(19) United States
(12) Patent Application Publication
(10) Pub. No.: US 2018/0089738 A1
(43) Pub. Date: Mar. 29, 2018

(54) ENHANCING ONLINE CONSUMER PURCHASES THROUGH ANALYSIS OF PAST CONSUMER PURCHASES

(71) Applicant: International Business Machines Corporation, Armonk, NY (US)

(72) Inventors: Marco A. Deluca, Ontario (CA); Stefan A. Hepper, Morgan Hill, CA (US)

(21) Appl. No.: 15/275,805

(22) Filed: Sep. 26, 2016

(51) Int. Cl. G06Q 30/06

(52) U.S. Cl. CPC G06Q 30/0631

(57) ABSTRACT

Enhancing online purchases based on a user's previous purchases by monitoring for a purchase receipt indicating the purchase of at least one product by the user; analyzing the purchase receipt to extract data; analyzing the extracted data; categorizing the at least one product purchased with the extracted data and storing the product and extracted data in a repository. At least one product indicated on the purchase receipt is compared to previous purchases in a same category stored in the repository; and if a product indicated on the purchase receipt is not the same as previous purchases in the same category, a notification is sent to the user regarding differences.

### BACKGROUND

The present invention relates to analysis of a consumer's purchases, and more specifically to analysis of electronic order confirmations of purchases for support in relation to new orders and current orders.

### SUMMARY

According to one embodiment of the present invention, a method of enhancing online purchases based on a user's previous purchases is disclosed. The method comprising the steps of: a computer monitoring for a purchase receipt indicating the purchase of at least one product by the user; the computer analyzing the purchase receipt to extract data; the computer analyzing the extracted data; the computer categorizing the at least one product purchased with the extracted data and storing the product and extracted data in a repository; the computer comparing the at least one product indicated on the purchase receipt to previous purchases in a same category stored in the repository; and if a product indicated on the purchase receipt is not the same as previous purchases in the same category, the computer sending a notification to the user regarding differences.

According to another embodiment of the present invention, a computer program product for enhancing online purchases based on a user's previous purchases is disclosed. The computer program product comprising: a computer comprising at least one processor, one or more memories, one or more computer readable storage media, the computer program product comprising a computer readable storage medium having program instructions embodied therewith. The program instructions executable by the computer to perform a method comprising: the steps of: monitoring, by the computer, for a purchase receipt indicating the purchase of at least one product by the user; analyzing, by the computer, the purchase receipt to extract data; analyzing, by the computer, the extracted data; categorizing, by the computer, the at least one product purchased with the extracted data and storing the product and extracted data in a repository; comparing, by the computer, the at least one product indicated on the purchase receipt to previous purchases in a same category stored in the repository; and if a product indicated on the purchase receipt is not the same as previous purchases in the same category, sending, by the computer, a notification to the user regarding differences.

According to another embodiment of the present invention, a computer system for enhancing online purchases based on a user's previous purchases is disclosed. The computer system comprising a computer comprising at least one processor, one or more memories, one or more computer readable storage media having program instructions executable by the computer to perform program instructions. The program instructions comprising: monitoring, by the computer, for a purchase receipt indicating the purchase of at least one product by the user; analyzing, by the computer, the purchase receipt to extract data; analyzing, by the computer, the extracted data; categorizing, by the computer, the at least one product purchased with the extracted data and storing the product and extracted data in a repository; comparing, by the computer, the at least one product indicated on the purchase receipt to previous purchases in a same category stored in the repository; and if a product indicated on the purchase receipt is not the same as previous purchases in the same category, sending, by the computer, a notification to the user regarding differences.

### BRIEF DESCRIPTION OF THE SEVERAL VIEWS OF THE DRAWINGS

FIG. 1 depicts a cloud computing node according to an embodiment of the present invention.

FIG. 2 depicts abstraction model layers according to an embodiment of the present invention.

FIGS. 3A-3B show a flow diagram of a method of enhancing online purchases based on past purchases.

FIG. 4 shows a flow diagram of a method of enhancing online purchases for new products.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models

Characteristics are defined as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are defined as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are defined as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

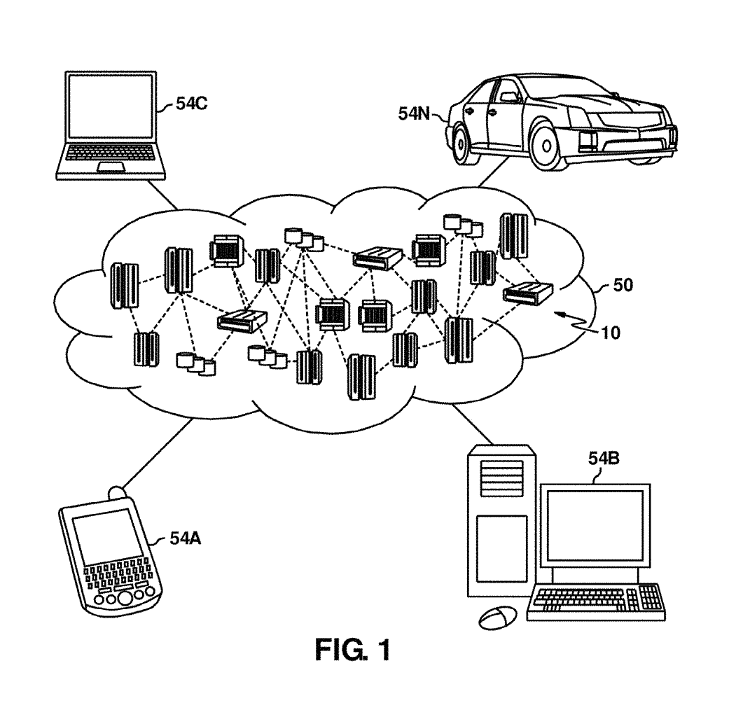

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

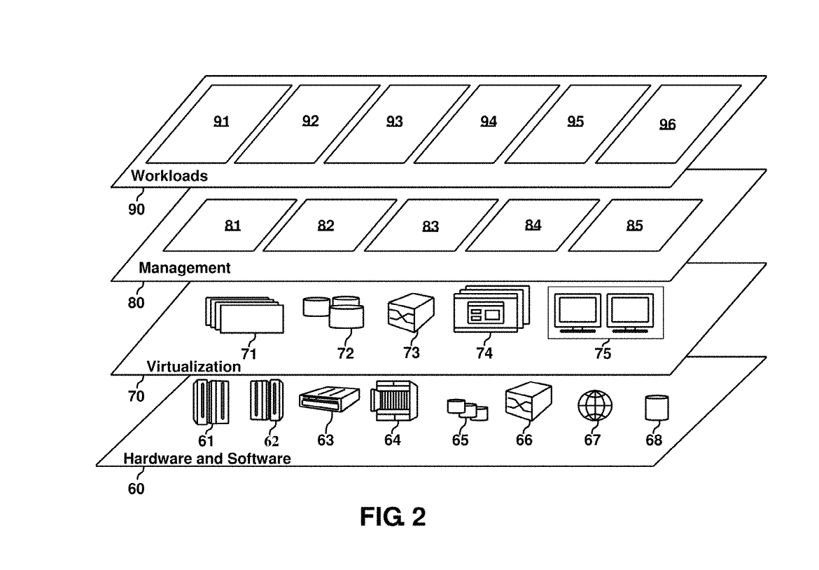

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and online purchase analysis 96.

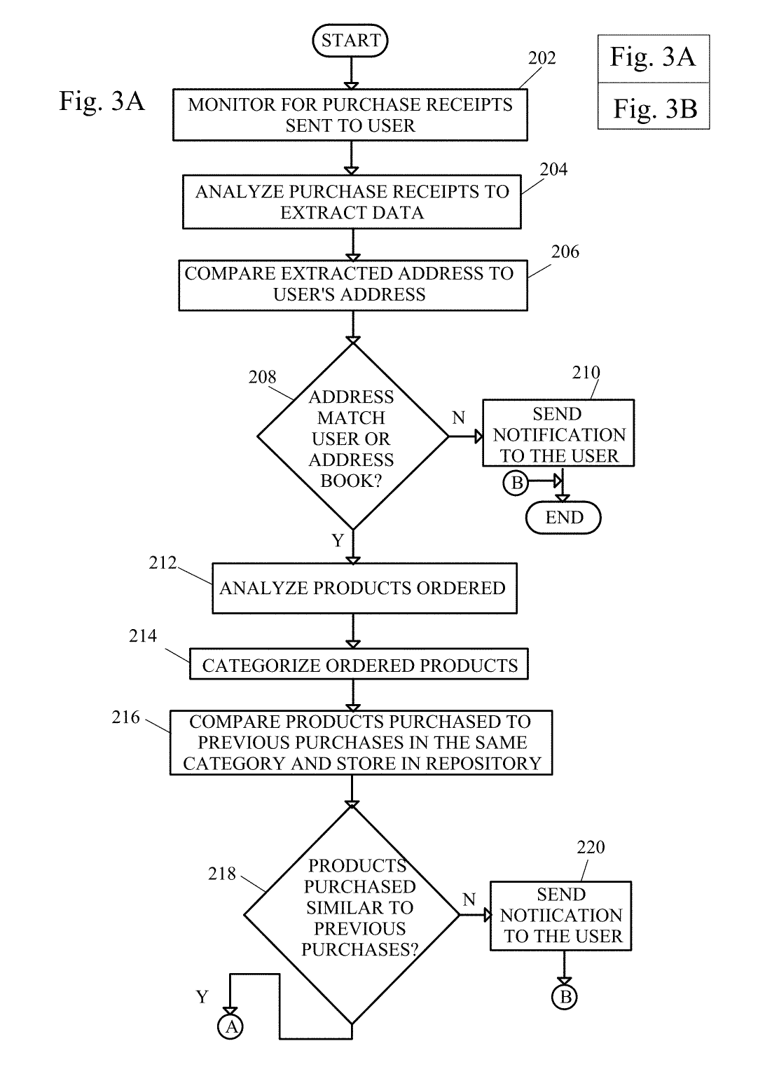

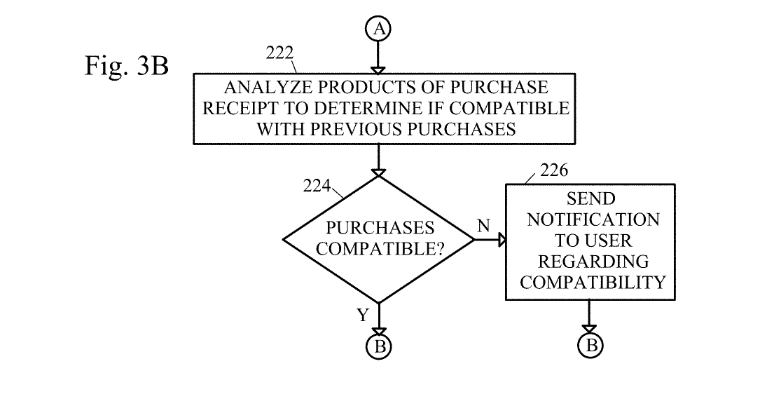

FIGS. 3A-3B show a flow diagram of a method of enhancing online purchases based on past purchases.

In a first step (step 202), purchase receipts sent to the user are monitored. The purchase receipts may include online confirmation regarding the purchase. The purchase receipts may have been sent via e-mail, text messages via short message services, or other means.

The purchase receipts are analyzed to extract data (step 204). The data to be analyzed may be, for example but not limited to: delivery address for the purchase, shipping address, product name; product description, a product identifier such as an SKU or UPC or other identification number or code, price, size, quantity, and date of order. The data is stored in a historical list in a repository. IBM® Watson, a technology platform that uses natural language processing and machine learning to reveal insights from large amounts of unstructured data, may be used to extract address information, such as a shipping address and product information from the purchase receipt.

The shipping address extracted from the purchase receipt is compared to the user's address and their address book of addresses for others (step 206).

If the shipping address extracted from the purchase receipt does not match the user's address or the addresses within an address book associated with the user (step 208), a notification is sent to the user (step 210) and the method returns to step 202. The notification may be via email, native mobile device notification, message via SMS or other means. The notification may contain instructions to the user to check the shipping address and if valid add it to the address book.

If the shipping address matches an address in the address book associated with the user or the user's address (step 208), the method continues to step 212 of analyzing and storing the products ordered by the user.

The products and associated data extracted from the purchase receipts are analyzed (step 212).

The products of the purchase receipt ordered are then categorized (step 214). The categories may be specific to a type of product, to characteristics of the product or usage of the product, or to a size of the product. The categorization may be carried out automatically by using image and/or text analysis through a technology platform, such as IBM® Watson. From the information extracted, the products on the purchase receipts can additionally be categorized by who the product is purchased for, if other than the user (i.e. for children, siblings, spouse, etc. . . . ) For example, categories of. house->maintenance->water filter.

The products of the purchase receipt are compared to previous purchases in the same category and stored in the repository (step 216).

If the products of the purchase receipt are similar to previous purchases (step 218), the products of the purchase receipt are analyzed to determine whether the products are “compatible” with previous purchases (step 222). The term “compatible” referring to whether previous purchases can be used together with the products of the current purchase. For example determining whether a newly purchased Brand A camera lens is compatible with a previously purchased Brand D camera.

If the products of the purchase receipt are compatible with the previous purchases of the user (step 224), the method ends.

If the products of the purchase receipt are not compatible with the previous purchases of the user (step 224), a notification is sent to the user regarding compatibility (step 226) and the method ends.

If the products of the purchase receipt are not similar to previous purchases (step 218, a notification is sent to the user (step 220) and the method ends. The notification may be via email, native mobile device notification, message via SMS, mobile application or other means. The notification may highlight any information on the order that does not match the personal information of the user or past purchases and may require a confirmation from the user or may provide the user an opportunity to provide additional information to aid the technology platform is determining what product would be appropriate for the user. For example, the notification may be “We noticed that you purchased engine oil 20W50, which does not match the recommended engine oil of your vehicle. If this purchase is correct, please confirm through the following link.” The link displayed within the notification can provide a confirmation that this product is correct and may allow the user to enter additional information regarding the vehicle in which the oil was being purchased for and why it was being purchased. The system may include additional products that may be used with the product being purchased. For example, with the 20W50 oil, a specific oil filter for the vehicle of the user may be suggested.

Alternatively, the link in the may be used to change an order or confirm that the product ordered was incorrect, providing an opportunity for the user to alter the product being purchased.

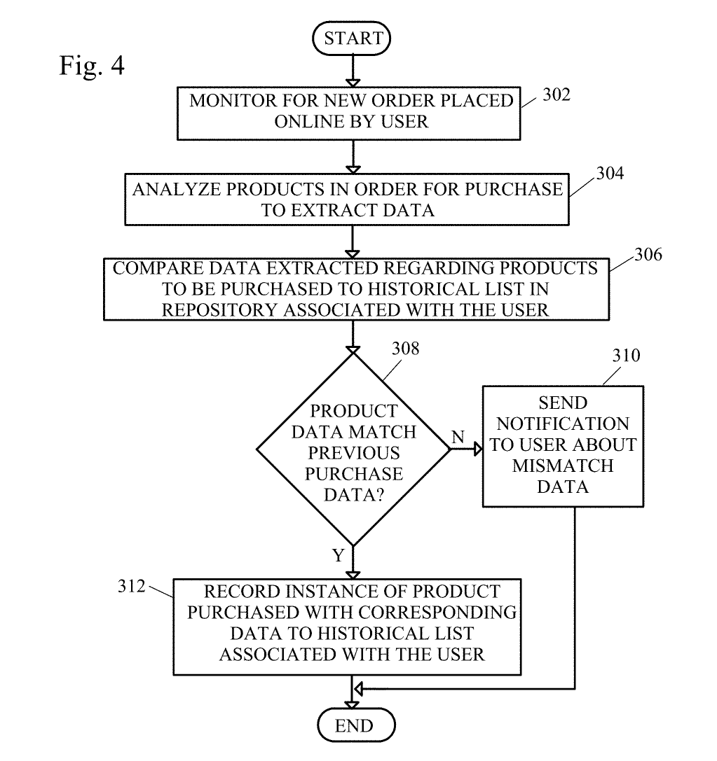

FIG. 4 shows a flow diagram of a method of enhancing online purchases for new products. The method of FIG. 4 is preferably conducted through a plugin in a browser being used by the user during their online purchase.

In first step (302), new orders being placed online are monitored for, for example through the plugin. For example, specific user actions may indicate that an order is being placed and may be monitored for, for example placing items in a cart.

Products present in a cart for purchase are analyzed (step 304), for example by a text analytics system of the plugin, such as IBM® Watson, to extract data, for example, but not limited to: product name, product description, a product identifier such as an identification number or stock keeping unit code (SKU) or universal product code (UPC) or similar, price, size, and quantity.

The data regarding the product is compared to a historical list in a repository associated with a user and representing past purchases made by the user (step 306). The historical list may be stored in the hardware and software layer 60 and/or virtualization layer 70 of the cloud computing environment 50.

If the product in the cart and the extracted associated data matches data present in the historical list (step 308), an instance of the product being purchased is recorded to the historical list in the repository (step 312) and the method ends.

If the product in the cart is present in the historical list and the product associated data extracted does not match the data present in the historical list (step 308), a notification is sent to the user regarding the discrepancy (step 310) and the method ends.

The notification may include questions or additional information posed to the user to determine whether the product being ordered is correct, as well as specific merchants the product was purchased from, whether the price, size or any other product attribute deviated from previous purchases.

For example, suppose size S was ordered in the past, but size L is currently being ordered. The notification may provide the discrepancy and ask the user whether the information should be updated in the historical list. Or, for example, ordering a replacement water filter for a refrigerator of GSWp was ordered previously, but the user selected GSWf, the notification may include a question to the user regarding the type of refrigerator or opening in which the water filter is to be received.

In an alternate embodiment, if the product in the cart is present in the historical list and the product associated data extracted does not match the data present in the historical list (step 308), a cognitive search of external resources may be searched to find if the new product is related to an existing order to determine whether the previously purchased product may be equivalent to the current product in the cart, for example using IBM Watson.

If the product in the cart is not equivalent to the previously purchased product, a notification is sent. If the product in the cart is equivalent to the previously purchased product, the historical list is updated to include the equivalent product.

For example, a user places water filter GSWf in the cart and the user has previously ordered a replacement water filter of GSWp. Since the water filters differ, external sources such as manual for a refrigerator in which the replacement water filters are commonly ordered cites that GSWf is equivalent to GSWp, the historical list of purchases is updated to include that the water filter GSWf is equivalent to GSWp.

Alternatively, when a user is ready to make a purchase, the user may activate the method of FIG. 4 from step 304 through a plugin in a browser that can analyze the current page and extract the product information.

It should be noted that in an embodiment of the present invention, upfront registration of the user is not required, since the historical list of the user's purchases is based on and discovered from the receipts of the goods that have been previously purchased and compiles that list of likes/sizes/etc. The present invention analyzes across vendors and can be proactive in giving recommendations.

Certain embodiments of the present invention implements an automated comparison of a product purchased to previous purchases in a same category by a user to determine whether products are purchased in error, or if there is an error in the information associated with the purchase. This automation is not just organizing information, but is using a comparison of newly received information to previous purchases made by a user in a specific way to ensure that a user is purchasing an appropriate product based on prior purchases.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method of detecting potential errors in online purchases based on a user's previous purchases comprising the steps of:
a computer monitoring for a purchase receipt indicating the purchase of at least one product by the user;
the computer analyzing the purchase receipt to extract data;
the computer analyzing the extracted data;
the computer categorizing the at least one product purchased with the extracted data and storing the product and extracted data in a repository;
the computer comparing the at least one product indicated on the purchase receipt to previous, historical purchases in a same category purchased by the user, stored in the repository;
the computer determining a difference between the at least one product indicated on the purchase receipt and previous, historical purchases in the same category purchased by the user;
the computer sending a notification to the user regarding the existence of a potential error based on the difference, with a suggested alternate product for purchase by the user; and
the computer presenting the user with access to the purchase receipt, permitting the user to alter the at least one product on the purchase receipt being purchased by the user online.

2. The method of claim 1, further comprising the steps of the computer:
extracting a shipping address of the user from the purchase receipt;
comparing the extracted shipping address to an address book of the user; and
if the shipping address does not match an address of the address book, sending a notification to the user regarding differences between the extracted shipping address and addresses in the address book of the user.

3. The method of claim 2, wherein the address book comprises a user's address.

4. The method of claim 1, wherein the data extracted is selected from a group consisting of: delivery address for the purchase, shipping address for the purchase, product name; product description, product identifier, price, size, quantity, and date of order.

5. The method of claim 1, wherein the notification to the user further comprises information which is different from the purchase receipt and the previous purchases.

6. The method of claim 5, wherein the information is selected from a group consisting of: model number, size, product name, price, merchant ordered from, and product attribute.

7. (canceled)

8. A computer program product for enhancing online purchases based on a user's previous purchases, a computer comprising at least one processor, one or more memories, one or more computer readable storage media, the computer program product comprising a computer readable storage medium having program instructions embodied therewith, the program instructions executable by the computer to perform a method comprising: the steps of:
monitoring, by the computer, for a purchase receipt indicating the purchase of at least one product by the user;
analyzing, by the computer, the purchase receipt to extract data;
analyzing, by the computer, the extracted data;
categorizing, by the computer, the at least one product purchased with the extracted data and storing the product and extracted data in a repository;
comparing, by the computer, the at least one product indicated on the purchase receipt to previous, historical purchases in a same category purchased by the user, stored in the repository;
determining, by the computer, a difference between the at least one product indicated on the purchase receipt and previous, historical purchases in the same category purchased by the user;
sending a notification, by the computer, to the user regarding the existence of a potential error based on the difference, with a suggested alternate product for purchase by the user; and
presenting, by the computer, the user with access to the purchase receipt, by the computer, permitting the user to alter the at least one product on the purchase receipt being purchased by the user online.

9. The computer program product of claim 8, further comprising the program instructions of:
extracting, by the computer, an address of the user from the purchase receipt;
comparing, by the computer, the extracted address to an address book of the user; and
if the addresses do not match, sending, by the computer, a notification to the user regarding differences between the extracted shipping address and addresses in the address book of the user.

10. The computer program product of claim 9, wherein the address book comprises a user's address.

11. The computer program product of claim 8, wherein the data extracted is selected from a group consisting of: delivery address for the purchase, shipping address for the purchase, product name; product description, product identifier, price, size, quantity, and date of order.

12. The computer program product of claim 8, wherein the notification to the user comprises information which is different from the purchase receipt and the previous purchases.

13. The computer program product of claim 12, wherein the information is selected from a group consisting of: model number, size, product name, price, merchant ordered from, and product attribute.

14. A computer system for enhancing online purchases based on a user's previous purchases, the computer system comprising a computer comprising at least one processor, one or more memories, one or more computer readable storage media having program instructions executable by the computer to perform the program instructions comprising:
comparing, by the computer, the at least one product indicated on the purchase receipt to previous, historical purchases in a same category purchased by the user, stored in the repository;
determining, by the computer, a difference between the at least one product indicated on the purchase receipt and previous, historical purchases in the same category purchased by the user;
sending a notification, by the computer, to the user regarding the existence of a potential error based on the difference, with a suggested alternate product for purchase by the user; and
presenting, by the computer, the user with access to the purchase receipt, by the computer, permitting the user to alter the at least one product on the purchase receipt being purchased by the user online.

15. The computer system of claim 14, further comprising the program instructions of:
extracting, by the computer, an address of the user from the purchase receipt;
comparing, by the computer, the extracted address to an address book of the user; and
if the addresses do not match, sending, by the computer, a notification to the user regarding differences between the extracted shipping address and addresses in the address book of the user.

16. The computer system of claim 15, wherein the address book comprises a user's address.

17. The computer system of claim 14, wherein the data extracted is selected from a group consisting of: delivery address for the purchase, shipping address for the purchase, product name; product description, product identifier, price, size, quantity, and date of order.

18. The computer system of claim 14, wherein the notification to the user comprises information which is different from between the purchase receipt and the previous purchases purchase.

19. The computer system of claim 18, wherein the information is selected from a group consisting of: model number, size, product name, price, merchant ordered from, and product attribute.

20. (canceled)
